(19) United States
(12) Patent Application Publication
(10) Pub. No.: US 2012/0158492 A1
(43) Pub. Date: Jun. 21, 2012

(54) METHOD AND SYSTEM FOR ATTENTION BASED ADVERTISEMENT INSERTION

(75) Inventors: Jerry Ye, Oakland, CA (US); Jyh-Herng Chow, San Jose, CA (US)

(73) Assignee: Yahoo! Inc., Sunnyvale, CA (US)

(21) Appl. No.: 12/970,340

(22) Filed: Dec. 16, 2010

(51) Int. Cl. G06Q 30/00

(52) U.S. Cl. 705/14.49; 705/14.4; 705/14.69

(57) ABSTRACT

Disclosed is a method and system for providing attention based advertisement insertion within media content. By placing advertisements within media where there is the most user attention and interest, the system provides a more attractive audience to advertisers. This potentially leads to increased return of interest (ROI) on the advertisement. Additionally, this can enable the media to be comprised of fewer advertisements, and reduce advertisement related abandonment.

### FIELD

The present disclosure relates to inserting advertisements, and more specifically to a method and system for inserting advertisements into content based on attention mapping of the content.

### RELATED ART

The Internet and other networks are commonly used to delivery media objects (video files, streaming media data, music/audio files, text, images files etc.) to end-user consumers. Typically, a consumer accesses such media by sending a request (typically via a browser program on the consumer's client computer) to a media server. In response, the media server retrieves the media data and transmits it to the consumer's computer, where it is rendered.

### SUMMARY

The present disclosure is directed to systems and methods for allowing publishers and advertisers to modify and propagate advertisements placed within media according to the consumer's attention to specific points or segments of the media. The present disclosure is directed towards systems and methods for providing attention based advertisement insertion within media content. By placing advertisements within media where there is the most user attention or interest, the system provides a more attractive audience to advertisers. This can potentially lead to increased return of interest (ROI) on the advertisement. Additionally, this can enable the media to be comprised of fewer advertisements, and reduce advertisement related abandonment.

In an embodiment, a method is disclosed for attention based advertisement insertion. A request from a user is received at a computing device. The request identifies a media file. The media file is retrieved from a media file database. The method then identifies a log file from a log database that corresponds to the media file. The log file includes quantitative measurements related to the rendering history of the media file among similar users. The quantitative measurements are based on a measure of how much attention is registered in connection with segments of the media file. The method selects an advertisement from an advertisement database, and appends the selected advertisement to the media file at or around the location or segment within the media file having the highest popularity. In some embodiments, several advertisements can be chosen for multiple popular segments of the media. The method then transmits the media file and the selected advertisement to the user over a network.

According to some embodiments, the advertisement or advertisements can be inserted or appended into the media file immediately prior to the segment or segments having the highest popularity. This ensures that upon a user rendering the media file, the advertisement(s) will be played immediately prior to the segment(s) with the highest popularity.

In another embodiment, a computer-readable storage medium is disclosed for attention based advertisement insertion. A request from a user is received at a computing device. The request identifies a media file. The media file is retrieved from a media file database. A log file is identified from a log database that corresponds to the media file. The log file includes quantitative measurements related to a rendering history of the media file. The quantitative measurements are based on a measure of attention registered in connection with segments of the media file. An advertisement is selected from an advertisement database, and appends the selected advertisement to the media file at or around the location having the highest popularity. Then, the media file and the selected advertisement are transmitted to the user over a network

In yet another embodiment, a system for attention based advertisement insertion. The system includes a plurality of processors, comprises a media module and an advertisement selection module. The media module retrieves a requested media file from a media file database and streams the requested media file to a rendering device. The requested media file was requested by the rendering device. The media module further accesses a log file stored in a log database for the media file. The log file includes quantitative measurements for segments of the media file. The media module identifies the media file segment having the highest quantitative measurements. The advertisement selection module accesses an advertisement database, selects an advertisement in accordance with the media file segment having the highest quantitative measurements, and transmits the advertisement to the requesting device with the media file segment.

According to some embodiments, the quantitative measurements for each media file are calculated by a backend server, where the backend server monitors user interaction and behavior when the media files stored in the media file database are being rendered, and stores the interactions and behavior in the log database as log files. According to some embodiments, the backend server calculates the quantitative measurements by analyzing a heat map for each media file, wherein the heat map for each media file identifies popularity of each segment of the media file, wherein said identified media file segment has a highest popularity among the segments of the media file. Heatmaps can be generated based on aggregate interaction logs of similar users. Thus, in some embodiments, when a user or users visit and revisit a certain segment of media, that segment become incrementally more popular (or “hotter”) in the interaction logs.

These and other aspects and embodiments will be apparent to those of ordinary skill in the art by reference to the following detailed description and the accompanying drawings.

### BRIEF DESCRIPTION OF THE DRAWINGS

In the drawing figures, which are not to scale, and where like reference numerals indicate like elements throughout the several views:

FIG. 1A illustrates a heatmap in accordance with some embodiments of the present disclosure;

FIG. 1B illustrates an example of information encoding in accordance with some embodiments of the present disclosure;

FIG. 1C illustrates rendering of a video clip in accordance with some embodiments of the present disclosure;

FIG. 1D illustrates an example, shown graphically, of user behavior during rendering of media in accordance with some embodiments of the present disclosure;

FIG. 2 illustrates an architecture for rendering media with attention based advertisements in accordance with an embodiment of the present disclosure;

FIG. 3 is illustrates a method for displaying an attention based advertisement in accordance with an embodiment of the present disclosure;

FIG. 4 illustrates a method for displaying an attention based advertisement in accordance with an embodiment of the present disclosure;

FIG. 5 is a flowchart depicting steps of a method for providing an advertisement with a media file in accordance with an embodiment of the present disclosure;

FIG. 6 is a block diagram illustrating an internal architecture of a computing device in accordance with an embodiment of the present disclosure.

### DESCRIPTION OF EMBODIMENTS

Embodiments are now discussed in more detail referring to the drawings that accompany the present application. In the accompanying drawings, like and/or corresponding elements are referred to by like reference numbers.

Various embodiments are disclosed herein; however, it is to be understood that the disclosed embodiments are merely illustrative of the disclosure that can be embodied in various forms. In addition, each of the examples given in connection with the various embodiments is intended to be illustrative, and not restrictive. Further, the figures are not necessarily to scale, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

The present disclosure is described below with reference to block diagrams and operational illustrations of methods and devices to insert advertisements based on attention mapping of content. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

The principles described herein may be embodied in many different forms. The systems and methods herein can add an advertisement or ad placement element to any streaming or downloaded media content (e.g., music, movies, slideshows, news articles, web pages, etc.) currently playing or being viewed on any computing device. The present disclosure is directed to the identification of positions of interest within media content. The systems display an ad at the opportune moment in time as the content is rendered (i.e., plays) on the device. The systems and methods may be used with media content of any type including audio streams, video streams, downloaded media, tethered download, interactive applications or any other media content item. The computing device may be any computing device that may be coupled to a network, including, for example, personal digital assistants, Web-enabled cellular telephones, TVs, devices that dial into the network, mobile computers, personal computers, Internet appliances, wireless communication devices and the like.

The media content, as discussed above, can be of any form: video, text, audio, images, etc. Typically, media content being streamed or transmitted to a user comprises information encoded as information units that are rendered for display or presentation to the user. The media content can be of any form: video, text, audio, images, etc. For example, an MPEG-encoded video file employs a number of layers of different types of encoded frames. The video frames are reconstructed from an MPEG-encoded video file frame-by-frame. Rendering of an MPEG-encoded video file provides a stream of frames being received and processed by a rendering device. Within each type of content, there are generally particular points or segments that a viewer considers of interest or pays a high amount of attention to. The present disclosure discusses inserting advertisements during or proximate to those peak interest areas in order to maximize the attention that advertisers receive for their advertisements, while minimizing abandonment of the overall content and the advertisement. For sake and ease of explanation, the type of media content used to describe the current system will be that of video content. However, this should not be considered a disclaimer of or be understood to exclude embodiments of those implementing other forms of media content.

Advertisements can be videos, motion graphics, images, banners, or in other static or media rich formats. Advertisements can be either skippable or un-skippable, which is determined by the advertiser or publisher of the content. For video content, in addition to the more traditional intermission type ads, advertisements can be overlaid on top of existing content, such as replacing a wall or billboard. For non-video content, ads can be placed adjacent to the content. An advertiser pays for their advertisement to be presented in front of users. The present disclosure ensures that the presented advertisements are located at or around the most viewed portions of content.

Segment popularity of, by way of a non-limiting example, an online video, can be quantitatively measured by how often and how long users watch or replay a particular segment or portion. Collected user interaction data, in some embodiments, can also be personalized by restricting the set of user data analyzed, in conjunction with the analysis based on other/similar users. By way of a non-limiting example, one way of determining the popularity of different parts of a video is to collect user data representing interactions by users with an item of media, such as a video. The collected user interaction data can be analyzed to determine what portions, points or segments of a media item users are viewing most. In other words, what segments receive the most user attention. The disclosed system learns from user behavior and feedback related to a media item, and identifies the locations within the media item where users have repeatedly rewound to (or in its proximity) to replay the content. The collected and stored data can then be used to make quantitative measurements. In other words, the data can be analyzed using known techniques to provide a mathematical visual representation of the segments. As discussed below, the quantitative measurements can be based on how often a portion, point or segment is consumed by a user, or similar user.

In accordance with the embodiments of the present disclosure, the system may use a specific attention model to define a context for processing media content, where the context can create a taxonomy and/or weighting condition for attention types. For example, in certain contexts, one type of attention may be valued over another, e.g., a user constantly rewinding a video clip vs. the user fast forwarding the video clip. By modeling the types and forms of attention, the resistance and affordance of attention given a segment of media content can create a unique graph of n-dimensional topology. This topology can be used as a unique identifier for a segment of media or as an attention vector for the media content. As such, any type of data analysis methodology that would yield popularity of segments of media content can be utilized by the various embodiments described herein, for example, a “heat map”.

Heat maps can be used to depict how much attention a specific portion or segment of a media area gets from consumers or similar consumers. These maps provide visual insight into consumer behavior. The heat maps provide an indication as to what content the viewing consumers care about the most, what they read/watch, and what they completely skip over. In other words, the maps assist in deciphering what most users on average are clicking on or gravitating to. The heat map can be constructed using data from aggregated user logs on a backend server, for example. Heatmaps can be generated based on aggregate interaction logs of similar users. Thus, in some embodiments, when a user or users visit and revisit a certain segment of media, that segment become incrementally more popular (or “hotter”) in the interaction logs.

Heat maps can also be computed for non-video content. For example, electronic books, magazines, songs, video games, traditional TV programming, etc. For a news article or a web page, how often a user has scrolled to a particular part of the page can be tracked. In these instances, eyeball tracking can be utilized. The most viewed and reviewed part of an article or web page will be the hottest part in the heat map.

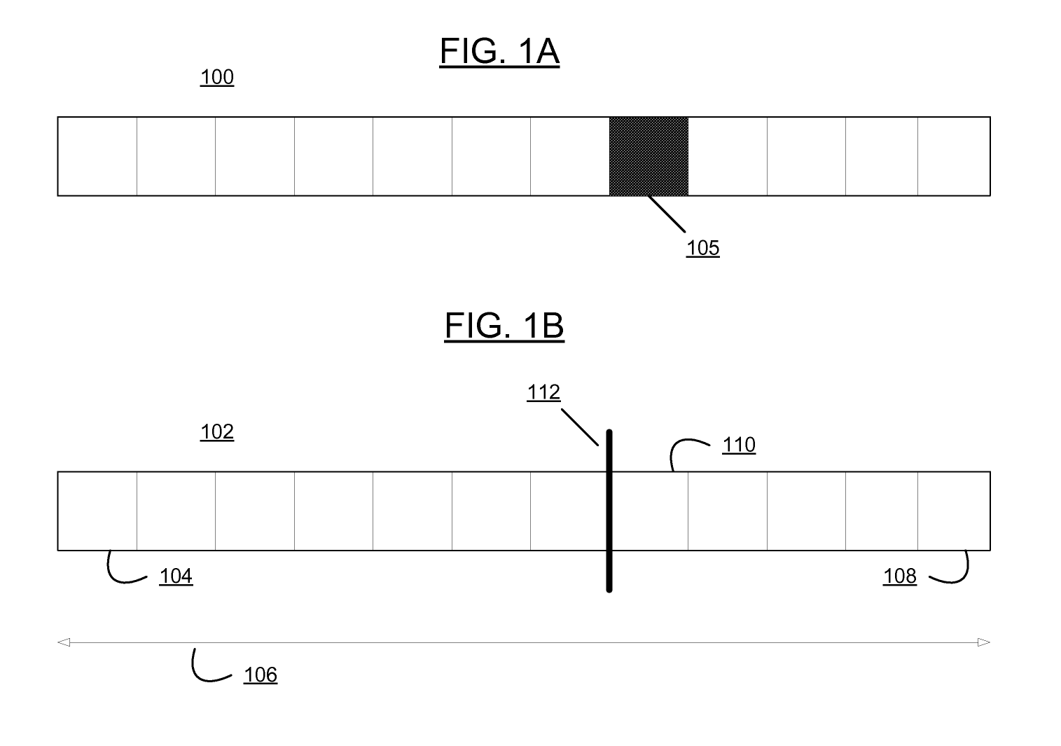

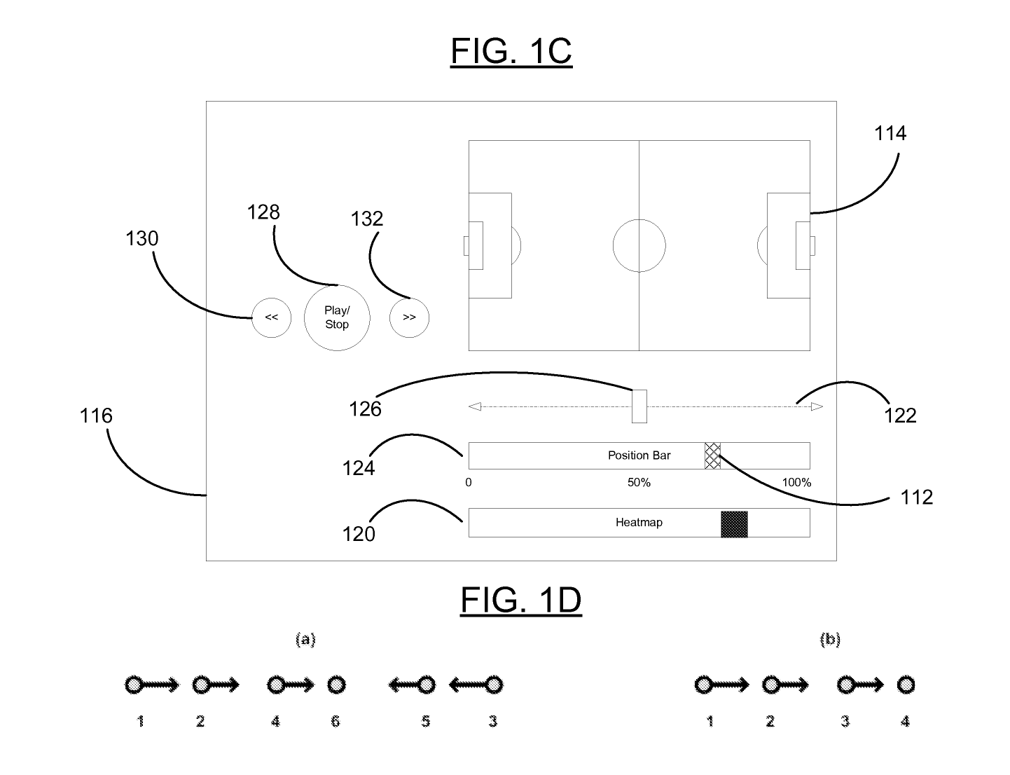

FIG. 1A shows heatmap 100 for a media file. As illustrated, the media file begins at the left, and ends at the right. The interestingness of the media file is not evenly distributed over the length of the content. Most commonly, the more popular parts of a heatmap are indicated by a redder shade while unpopular parts are a darker shade. Embodiments can also exist where differing levels of a gray-scale or color scheme can denote the level of interest. This can be referenced by a legend, or supplemental documentation. As such, heatmaps may use differences in shading, colors, or other visual cues in order to represent the magnitudes of relatedness metrics computed for positions within media content. For illustrative purposes with reference to FIG. 1A, the popular region of the heatmap will be shaded dark, while the low interest regions will not be shaded. This is solely for illustrative purposes to highlight the locations of interest within a media file, and should not be viewed as a limiting nature of the disclosed heatmaps.

As depicted in FIG. 1A, segment 105 represents the segment or portion with the highest point of interest within a media file. The types of user behavior that can contribute to feedback for formulation of a heatmap include, but are not limited to, a user rewinding to a previously viewed location, a user enlarging the screen at a certain point during rendering, a user abandoning the video during rendering, a user fast forwarding through a segment, and the like (as illustrated in FIG. 1D).

FIG. 1B depicts an encoding of the media content from FIG. 1A, where the progress of the rendered media content begins at the left and ends at the right. Such depiction shows a sequentially ordered information encoding of the media content. The encoding can comprise an ordered sequence 102 of information units, including, for example, information unit 104, which is first unit within the sequence. As in FIG. 1B, the information unit depicted on the left, unit 104, represents the initial information unit that is to be rendered, while the information unit depicted on the right, unit 108, represents the final information unit that can rendered within the media file.

The location of any particular information unit in the ordered sequence of information units can be described by a position within the ordered sequence of information units. Most types of electronically encoded information can be considered to be ordered sequences of information units. For example, files stored within a computer system can be broken down to arrays of bytes, with the position of each byte indicated by an index or byte offset from the beginning of the file. In FIG. 1B, positions within the media content are represented by a horizontal position axis 106 parallel to the ordered sequence of information units. A position can be expressed as an index, in temporal units, or in other ways known in the art.

In FIG. 1B, unit 110 directly corresponds to location 105 on the heatmap 100 in FIG. 1A. As discussed above, location 105 represents the segment of the media file having the highest attention. As such, by way of example, an advertisement, ad marker or ad pointer can be placed immediately prior to the corresponding location in the media file. In some embodiments as discussed below, the advertisement, ad marker or ad pointer can be placed prior to, or at or around the corresponding location. Thus, according to some embodiments, an advertisement, ad marker or pointer 112 is inserted into the media file to indicate that at that position, an advertisement is to be rendered prior to the rendering of unit (or segment) 110.

FIG. 1C illustrates rendering of a video clip by a media player incorporated in, or accessed by, a web browser or application program that displays a web-page graphical user interface (GUI) on a display of a computing device. Video is displayed within a video screen 114 provided by the GUI 116. A progress display 122 displays, to a user, an indication of the current position within a video clip being displayed during rendering. The entire length of the video clip is represented by horizontal/position bar 124. The current position is indicated by position indicator 126. The position indicator 126 indicates that the currently displayed video frame occurs at a position 50% of the way through the clip. The user interface provides a start/stop button 128 for starting and stopping video clip display, as well as a backward-advance button 130, and forward advance button 132 that allows the user to seek different positions within the video clip without watching intervening frames. Users are also able to skip to certain segments anywhere along the progress display 122 and/or the position bar 124.

As discussed above, an advertisement 112 can be inserted within a media file, as shown within the position bar 124. According to some embodiments, instances can exist where an advertisement marker may be shown to a viewing user. In these cases, an identifier would be placed within the horizontal bar 124. In some embodiments, the advertisement marker may also be placed within the progress display 112. According to some embodiments, advertisements can be placed at or around the area where the heatmap indicates high points of interest. In exemplary embodiments, the advertisements are inserted into media immediately prior to the high interest segment.

In some embodiments, heatmap 120 corresponding to the media content can be visibly displayed on the GUI 116. The heatmap 120 displays that a high popularity segment appears around three-fourths of the way through the media content. As illustrated, the advertisement 112 displayed on the bar 124 corresponds to the segment of the highest popularity as shown in heatmap 120.

As an example, FIG. 1D depicts slider (or position indicator 126) movements when a user views a video. This is demonstrative of the type of user behavior that is collected in determining high attention segments of media where advertisements ultimately will be placed. Each circle indicates the slider placement on a progress bar. The numbers indicate the sequence of movements, and the arrows indicate the direction. In case (a), the user moves the slider back-and-forth incrementally according to the numbered position points until point 6 where the user was finally satisfied. In other words, as illustrated, the user moves the slider from position points 1, to 2, 3, 4, 5, and finally point 6. In case (b), the user moves the slider in one direction and was satisfied at point 4. The system can infer that point 6 in case (a) and point 4 in case (b) are the high interest locations within the respective media files.

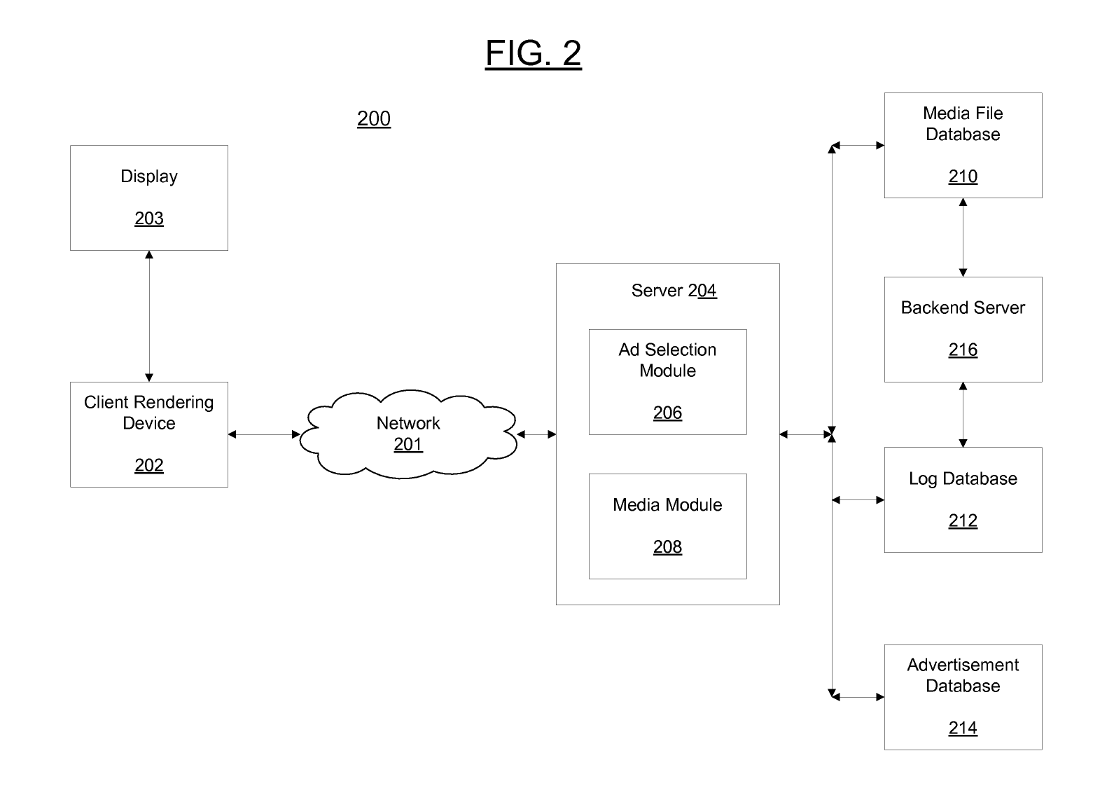

As discussed above, the described systems and methods disclose placing advertisements where there is the most user attention, and seek to determine and identify or isolate the most popular parts of content. this enables the insertion of advertisements before, during or right after the most popular segments. FIG. 2 illustrates an embodiment of an architecture for rendering media with advertisements. The architecture 200 is a computing architecture in which media is rendered by a rendering device 202. The architecture 200 illustrated is a networked client/server architecture in which a rendering device 202 (referred to as a “client”) issues media requests to a remote computing device 204 (referred to as a “server”), which responds by transmitting the requested media content to the client 202 for rendering to a user. The systems and methods described herein are suitable for use with other architectures as will be discussed in greater detail below.

For purposes of this disclosure, a computing device such as the client 202 or server 204 includes a processor and memory for storing and executing data and software. Computing devices may be provided with operating systems that allow the execution of software applications in order to manipulate data. In the embodiment shown, the client 202 can be a computing device, such as a personal computer (PC), web enabled personal data assistant (PDA), a smart phone, a media player device such as an IPOD, or smart TV set top box. The client 202 is connected to the network, such as the Internet, 201, via a wired data connection or wireless connection such as a wi-fi network, a satellite network or a cellular telephone network.

The client 202 includes an application for receiving and rendering media content. Such applications are commonly referred to as media player applications. The media player application, which runs on the client rendering device 202, includes a graphical user interface (GUI), which is displayed as attached to or part of the computing device 202 on a display 203. The GUI, as depicted in FIG. 1C, includes a set of user-selectable controls through which the user of the client device 202 can interact to control the rendering other media content. For example, the GUI on the client computing device 202 may include button control for each of the play-pause-rewind-fast forward commands commonly associated with the rendering of media on rendering devices. By selecting these controls, the user may generate rendering data from which a heat map for content can be generated, as discussed below.

The GUI on the display 203 can include at least one area that may be used for displaying advertisements when the client is rendering media content to the user. For example, if the media player is rendering an audio stream or audio object, such as a song, the GUI may denote an area within the display 203 for showing the advertisement if the ad is visual. Or it may be an audio advertisement inserted in the audio stream, or the audio may be halted or paused while the audio ad is streamed, accessed or played from an alternate location. This may also occur when rendering video content. However, exemplary embodiments dictate that advertisements can be displayed or experienced within the same viewing pane as that of the video content, in order to effectuate a greater ROI for the advertisement.

The architecture 200 also includes server 204, which may be a single server or a group of servers acting together, either at one location or multiple locations. A number of program modules and data files may be stored in a mass storage device and RAM on the server 204, including an operating system suitable for controlling the operation of a networked server computer.

In the architecture 200 shown, a client 202 is connected to a server 204 via a network 201, such as the Internet as shown. The client 202 is configured to issue requests to the server computer 204 for media content. In response, the server computer 204 retrieves or otherwise accesses the requested media content and transmits the content back to the requesting client 202. The requested media content may be stored as a discrete media object (e.g., a media file containing renderable media data that conforms to some known data format) that is accessible to the server 204. In the embodiment shown, a media file database 210 is provided that stores various media content objects that can be requested by the client 202.

The client 202, upon receipt of the requested media content, may download and store the media content for later rendering. Alternatively, the client 202 may render the media content as quickly as practicable while the content is being received in order to reduce the delay between the client request for content and the initiation of the rendering of the content to the user—a practice referred to as rendering “streaming media.” When rendering streaming media, the client 202 may or may not store a local copy of the received media content depending on the system.

In addition to transmitting the requested media content, the server 204 also is configured to select and transmit advertisements to the client 202. Advertisements are selected from an advertisement database 214 by an advertisement selection module 206 within the server 204 and inserted into, or transmitted in conjunction with the media content. The server 204 also includes a media module 208. The media module 208 is configured to request the media content from the media file database 210. The media module 208 and the advertisement selection module 206 collectively transmit content and appropriately and timely insert advertisements to the client 204 based on information stored in the log debase 212.

The log database 212 collects and stores information from a universe of users on a network concerning the users' or consumers' interactions or activity with the media content. The log database 212 is a data source from which the information collected is representative of quantitative measurements of how often and how long users watch or replay particular segments of the media content. According to some exemplary embodiments, popularity of different segments of media content is determined via a heat map or other clustering algorithm or data analysis technique. As discussed above, and understood by those skilled in the art, heat maps show how much attention a specific segment of media receives from consumers who have rendered the media. The heat maps provide insight into consumer behavior. The maps provide indicators as to which portions of media content the viewing consumers care about the most, what they read/watch, and what they completely skip over. For example, media segments that have been similarly tagged by a large number of users can be assumed to be segments that users are paying a lot of attention to.

The heat maps for each piece of media content, and their respective segments, are computed by the backend server 216 using data stored in user logs, or media logs, in the log database 212. The logs comprise quantitative measurements deduced from rendering operations as users interact with the client rendering device 202 and the accompanying GUI. As discussed above, a GUI displayed on display 203 can include button controls to play-pause-rewind-fast forward media content. The backend server 216 monitors these controls as a plurality of users interact with media, and generates rendering (or user activity) data from which a heat map for content can be visualized as sufficient user data is collected from the universe of users. The heat map can be stored as a log in the log database 212. The logs in the log database 212 can identify advertisement identifiers for different portions of media content. The ad identifiers pinpoint locations where advertisements can be inserted in the media content. The backend server further actively interacts with the log database 212 and the media file database 210 in order to monitor and analyze the rendering of the media content and users' behavior during rendering.

In some embodiments, user-specific heat maps can be generated for a particular user's viewing behavior by the backend server 216. This information (i.e., the user specific heat maps) would be stored as user specific logs within the log database 212. These individual heat maps can be constructed using existing machine learning techniques. In some embodiments, user specific logs may be formulated according to user demographic information including user age, location, income or interests. In an embodiment, user demographic information may be stored within the log database 212 and identified according to the particular user and/or which demographic the user or media file falls within. In some alternative embodiments, user logs can be stored on the server 204. In an alternative embodiment, user logs and demographic information may be stored within a client-side cookie on the client rendering device 202. In this instance, appended to the request for media content would be identifying information that the server 204 and log database 212 utilize to identify the user specific logs. In some alternative embodiments, the user may login via a login ID provided at a GUI on the display 203. This enables the user to be properly directed to his/her personal user logs stored in the log database 212.

Based on the information stored in the log database 212, server 204 can identify specific portions of the requested media that correspond to peak interest segments of the media. The heat map information for the media is stored in a log database 212. In this case, the server 204 receives not only the media content, but also the indicators that trigger advertisement insertion at the opportune times. Thus, the server 204 can select advertisements in accordance with the identified portions of the content in order to provide attention based ad insertion. The attention based ads are transmitted to the client 202 so that they can be displayed to the user as their associated portion of the media content is being rendered. In some embodiments, the ads that are selected can be selected based upon the media file, the identified segment or position of the media file (based on the heat map), and/or based upon user data collected in the log database 212.

This display of attention based advertisements may be more easily illustrated by an example. In one example, a user may request a video that is streamed to rendering device 202. As the video is being streamed (e.g., played on by the media player), the different portions of the video are transmitted to the user. If, for example, one portion of the video has been identified as the climax of the video by the log file for the video, where the majority of users have either replayed or paused the video during that portion, the server 204 identifies this segment and can serve an advertisement immediately prior to the rendering of said portion. Presenting an advertisement to user right before the hottest areas of the heat map for particular content will maximize the return on investment (ROI) for advertisers since user interest in the video is at its peak. By way of another example, presenting an advertisement right before the first kissing scene of the main actor and actress in a long cinematic drama guarantees that the advertiser has maximum audience attention.

Additionally, because advertisements are inserted right before the hottest attention areas, most users will typically watch the entire ad in order to get to the desired content. As discussed herein, advertisements placed right before a peak interest segment present the lowest risk of abandonment of the advertisement and content. Indeed, with improved ROI and a decreased abandonment probability, embodiments exist where the number of advertisements presented to users would be reduced. Thus, maintaining user interest and reducing advertisement fatigue of the viewer, users will be less likely to abandon the content. For example, if a three minute long video has an associated heat map that indicates there are two highly requested/viewed portions therewith, serving additional ads on top of the two advertisements could amount to overkill, and lead the viewer to abandon viewing the video. Thus, the ad insertion system would then only insert advertisements right before each of the two peak interest segments within the video.

As described above, for each media file rendered by the client 202, one, two or several ads could be displayed over the elapsed time of rending of the media file. In some embodiments, this is contingent upon the attention data for the specified media file. In some other embodiments, ad display is contingent upon the user's particular behavior log, as discussed in greater detail below. The system described additionally allows for different advertisements to be shown depending on the level of service provided to or purchased by the client 202. For example, ads shown to paying subscribers could be coupons, special offers, or other specialized incentives.

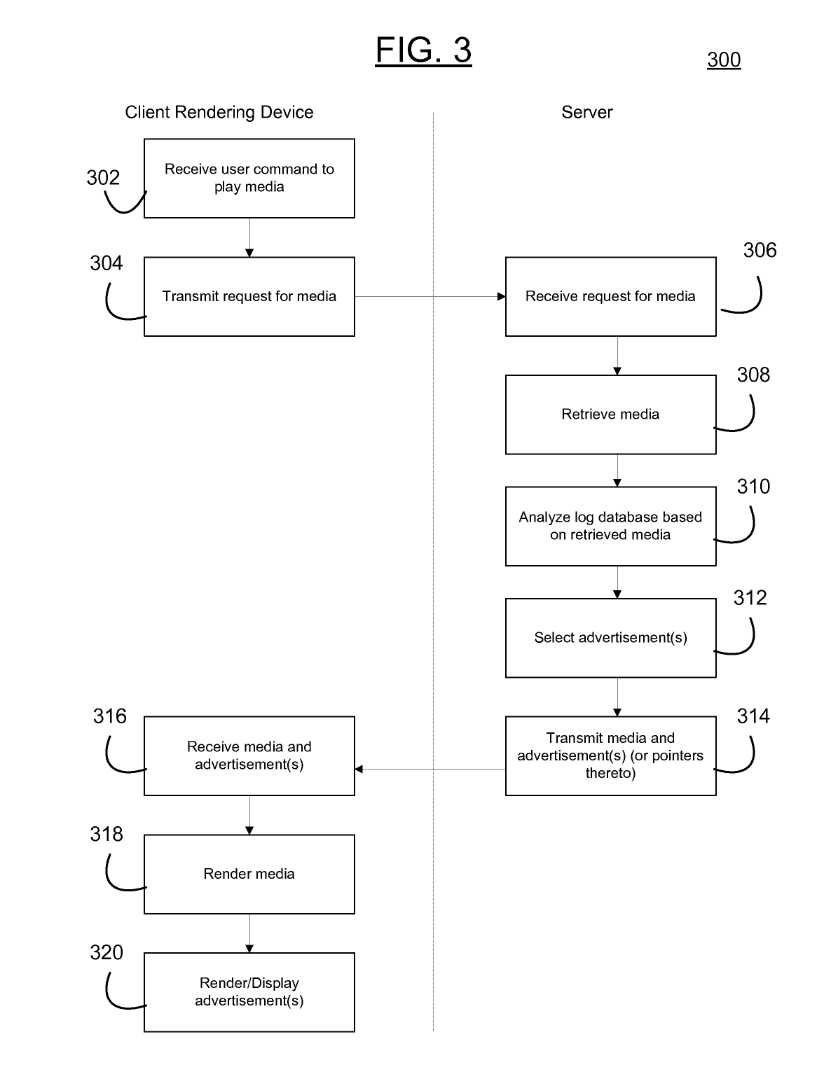

FIG. 3 illustrates an embodiment of a method for displaying an attention based advertisement. In the embodiment shown, the method 300 is a client/server method and illustrates some of the actions performed or controlled by each device.

The method 300 starts with a command, such as a user command, to render a media object, which for purposes illustration is a video file containing a music video. The command is received by the client in a receive render command 302. The command may be received via the GUI of the client, such as the GUI of a media player application running on the client device. Alternatively, the command may be a command identifying a media object such as a click on a hyperlink on a web page or in a playlist or an icon associated with the media file that results in the execution of the media player to retrieve and render the file.

The client resolves the command and instantiates the media player if necessary. In either case, a request is generated and transmitted for the media file identified by the command. Step 304. In Step 306, the request is received by the server. The request may include an identification of the user associated with the client, such as a user ID, as well as information identifying the client computing device to the client.

The media server retrieves the requested media file in step 308. According to some embodiments, this may include accessing a media file database as described above, or retrieving the media file from a cache, local memory or local data source such as a hard disk or CD. The server then polls the log database for information relating to the retrieved media. Information corresponding to high interest segments within the media file is analyzed to determine areas of high user interest. Step 310. The server then selects one or more advertisements for insertion into the media file. Step 312. The number of advertisements is, in some embodiments, based upon the number of high interest segments identified from the log database in Step 310. In some embodiments, publishers of content can set a number of advertisements to be inserted or rendered along with content. This is done so in order to avoid saturating the content with advertisements and to avoid annoying the viewer. Also, this assists in avoiding content abandonment and increasing the ROI of the inserted advertisements. In alternative embodiments, advertisers can set the number of advertisements for insertion.

The number of advertisements can be set according to a numerical or time-based threshold. For example, in a five minute media file, a threshold may be set to a total of three 30 second advertisements. Therefore, upon analyzing the media logs retrieved from the log database, the segments showing the three highest points of interest within the media will have advertisements inserted immediately prior. In some embodiments, time period restrictions can be set so that if two high points of interest fall within a respective time period, they both will not be preceded by advertisements. In this instance, either the first point of interest will preceded by an advertisement, or the higher rated segment will be preceded by an ad.

The advertisement(s) and the media file are transmitted to the client. Step 314. The advertisement and the media file may be transmitted together in a combined communication or the advertisement and the media file may be transmitted independently in a “just-in-time” manner—just before the moment that they are to be displayed to the user. In this embodiment, the client will then display each advertisement when it is received, and need not include logic for determining whether the advertisement should be displayed before or after the received segment. The “just-in-time” manner also enables the client to clearly process that the advertisement is to proceed the segment.

In Step 316, the advertisement and the media file are received by the client. As discussed above, this includes receiving a communication including information for rendering the advertisement and information for rendering the media file, or multiple separate and independent communications each containing different data. According to some exemplary embodiments, the communications of Steps 314 and 316 are performed according to the “just-in-time” manner and according to multiple separate and independent communications each containing different data. In step 318, the portions of media are rendered in order in which they are received, as they are transmitted in rendering order. Upon receiving a communication from the server identifying that an advertisement is to be displayed, the client performs a display advertisement operation and displays the selected advertisements prior to rendering the accompanying media segment. Step 320. In some embodiments, as discussed above, the advertisements may be set to be rendered before, during or after particular segments. This is based upon determinations made by advertisers and publishers of content. This can also be contingent upon the heat map, whereby there may be high interest content following a particular segment; therefore, it may increase the ROI to have the ad immediately trail the segment. The ad or advertisement marker may be inserted into the media file thereof, or ad points can be inserted so that the ads can be custom-tailored to an individual user.

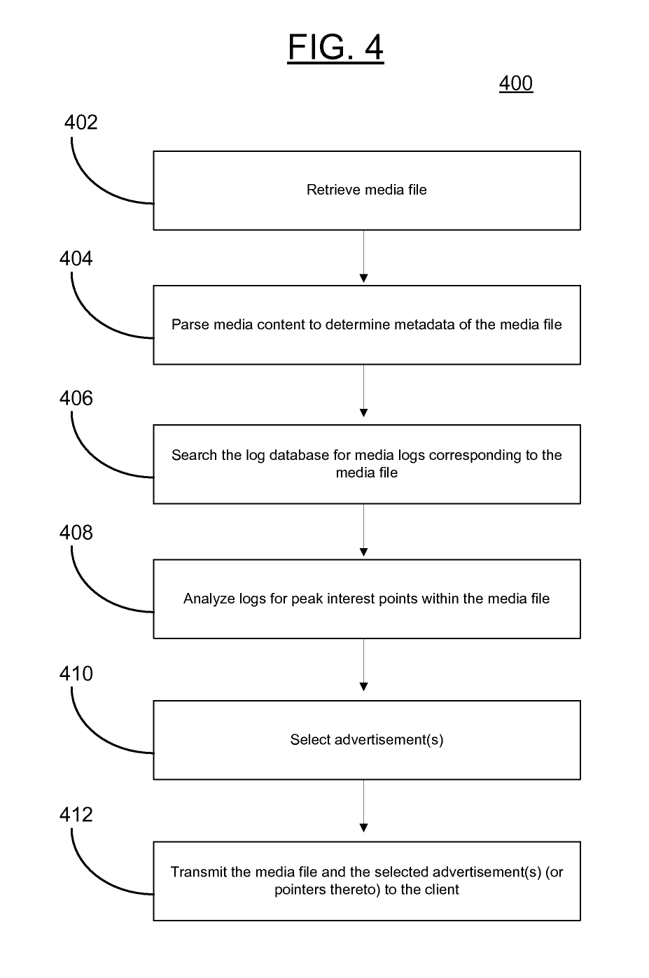

FIG. 4 illustrates an embodiment of a method for retrieving attention based advertisement information. The method 400 illustrates various operations that may be performed by a media server or may be distributed between several devices including the rendering device, and advertisement database or system and a media server or system.

The method begins with a media server retrieving a requested media file. Step 402. As discussed above, this may include accessing a media file database, or retrieving the media file from a cache, local memory or local data source. In Step 404, the media server parses the media file to determine identifying information relating to the media file. Such information can be metadata associated with portions of the media file. The metadata may also include keywords or advertisement markers for different portions of the media file. Additionally, the metadata may include demographic data identifying one or more demographic groups for which the media file, or more specifically portions of the media file, relate to. Based on this information, the server searches the log database for logs specific to the media file. Step 406. The logs provide quantitative measurements of how often and how long users watch or replay particular segments of the media content. According to some exemplary embodiments, popularity of different segments of media content is determined via a heat map. The heat maps show how much attention specific segments of the media items have received from a universe of users or from consumers who have rendered the media items. This information is stored as the log files for each media file. In other words, the heat maps provide insight into consumer behavior when rendering a media file. In Step 408, the logs are analyzed in order to identify indicators as to which portions of media content the viewing consumers care about the most, what they read/watch, and what they completely skip over. In other words, which portions of the media file are the highest points of interest.

In some embodiments, there may exist situations where media files do not have logs present in the log database. These instances arise when there is generally a low viewing history for the file, or if the file is new, or relatively new. In these instances, historical data of similar media files can be utilized to determine potential, or temporary points of interest, until the instant media file has generated enough data to exhibit reliable rendering habits. As discussed above, in Step 404, the media file is parsed, resulting in identified metadata for the media file. The metadata can provide demographic information, as well as the genre of media. With this information, a new media file, based on the parsed metadata, can be approximated to have similar points of interest to a similar known media file. For example, upon identifying a new media file without a log file, the server can search for other media files within the same genre in an effort to find similar attention areas and/or to determine what type of ad to place, e.g., an ad that is in some way related to the media item content, context, or past user behavior data. For example, the new and unknown video is a music video of a pop song. Generally, the specific points of interest of pop songs will set at the ⅓ marker and ⅔ marker in the video, as the most popular portion of these types of songs and videos are generally the chorus/refrain of the song—songs usually have 2 refrains and 3 verses. As such, since the new video has unknown quantitative values as per the log database, peak points of interest will initially be assumed to occur during the presumed refrains. These points will be maintained until enough data has been compiled from user rendering, where accurate historical/behavioral data (or points of interest via a heat map) can properly be identified. In some alternative embodiments, a specific user's behavior data can provide the adequate directive for determining points of interest. For example, if a user, upon viewing a music video, regularly stops the video half way, and replays the first portion of the video, points of interest for the unknown video may be set either at the beginning of the video, and/or immediately prior to the half-way point of the video. Accordingly, a confidence level can be set, so that after a number of times a media file has been rendered, the heat map's quantitative data that has been collected can be presumed accurate.

After the peak points of interest from the log have been identified, advertisements are selected. Step 410. In Step 412, the selected advertisement and the media file are transmitted to the client. As discussed above, the advertisement and the media file may be transmitted together in a combined communication or the advertisement and the media file may be transmitted independently in a “just-in-time” manner. The “just-in-time” manner also enables the client to process the rendering position of the advertisement in view of the accompanying segment.

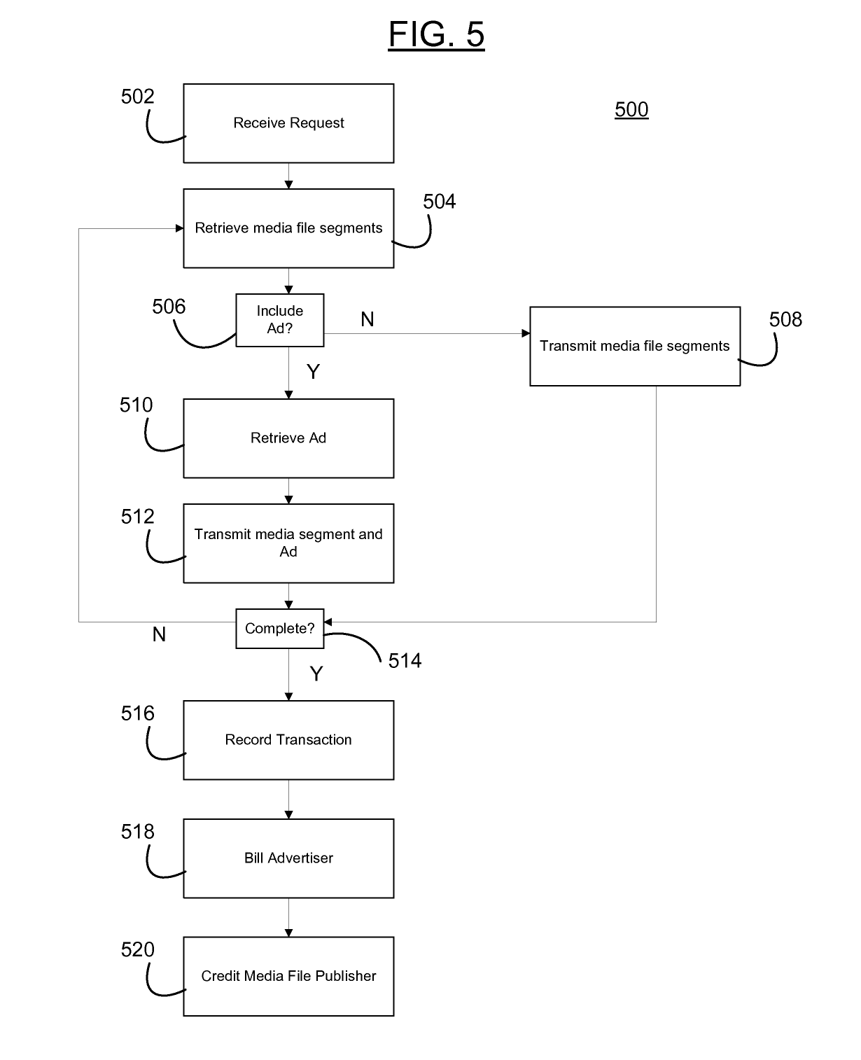

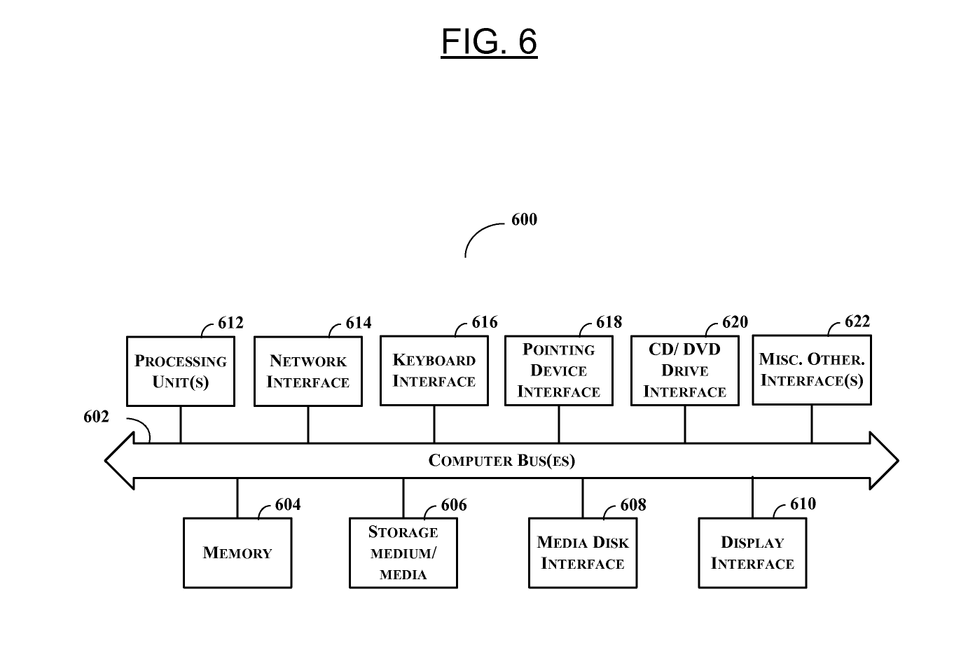

FIG. 5 is a flowchart depicting an embodiment of a method for providing an advertisement with a media file so that the two are consecutively rendered in a predetermined sequence, in accordance with the “just-in-time” manner (or streaming). In the embodiment 500, the method starts when a request is received. Step 502. The request is inspected for the type of media file, and the media file is retrieved from a media file database. Step 504.

Next, a determination operation 506 determines whether an advertisement should be provided with the response to the request. In this operation, each portion or segment of the media file is analyzed in accordance with the heat map information comprised within the associated log file for the media file stored in the log database. This determination may include inspecting the media file segments, and analyzing the relevant information contained within the associated log file for determining whether to include an ad, as discussed above. If the determination operation 506 determines that no ad should be provided with the segment, the media file segment is transmitted (or streamed to the client). Step 508. This is based upon the segment corresponding to a low interest point in the media file, as depicted by a dark color on a heat map.

If determination operation 506 determines that an advertisement should be provided with the media segment, a retrieve ad operation 510 is performed. This determination is based upon the media segment being identified as a high interest segment within the media file, as denoted by the associated heat map (and as determined from processing and analyzing log file data). As described above, one or more advertisements are selected from the advertisement database. In some embodiments, the retrieve ad operation 510 may be based on many different factors including the contents of the received request and/or media file segment, and/or may involve accessing and retrieving additional information from a user database (not shown) or the media file database.

After the ad is selected, the retrieve ad operation 510 retrieves the selected ad. In some embodiments, the ad may be retrieved from a local or remote location, such as an advertisement database. The ad retrieved may itself be in the form of a media file, or may be media data in a form ready for insertion into a file.

Next, the media file segment and the advertisement or pointers thereto (e.g., as part of a playlist file) are transmitted to the client as directed by the request. Step 512. As discussed above, in some embodiments, the transmission may include the media file segment and a separate advertisement file. In another embodiment, the transmission may include a single file containing the combined media file segment and the ad. In yet another embodiment, the transmission may be a stream of media data taken from the media file segment and the ad.

After Steps 508 and 512, the method determines if all of the media file segments of a media file have been transmitted. Step 514. If not, the method reverts to Step 504, where the remaining segments will be processed. If yes, the method continues to Step 516.

The method 500 includes a record transaction operation 516, whereby the details associated with ad transmissions are recorded for ad tracking purposes and other data mining or analysis reasons. The transaction operation 516 creates a record of what ads were provided with what media file segments and to whom. In addition, other information may also be recorded such as the requestor's demographic, the requestor's e-mail address or other identifying information, and the source of the media file. A bill advertiser operation 518 is performed in which the advertiser is billed for the delivery of the advertisement to the consumer. The bill advertiser operation 518 may periodically and automatically generate an electronic or paper invoice to advertisers based on the current contract between the advertiser and the operators of the advertisement insertion system. A pay publisher operation 420 may also performed in which the publisher or owner of the media file is credited or otherwise remunerated for the use of the media file as a vehicle for delivery of the advertisement to the consumer. The pay publisher operation 420 may automatically generate an electronic or paper payment or credit to the publishers or owners of the media files with which the advertisements are provided. Such payments or credits may also be determined based on a current contract between the publisher and the operators of the advertisement insertion system.

As discussed above, advertisements transmitted can be tracked during transmission for billing purposes (for example, to track click-throughs or purchases resulting from user interaction with the ad). The tracking of delivery of advertisements allows publishers of content to bill the advertisers and thereby receive payment for the media delivery service. Attention based ad insertion may also employ tiered pricing for ad delivery. Once a heat map of user attention for a media file is present, a tiered pricing system based on how “hot” or high user interest in the content is factors into the pricing scheme. In the video example, advertisements placed right before a climatic action sequence will command the highest premium. In another example, a scene where a protagonist is drinking a cup of coffee might command a significantly lower rate. However, cost should not be a monotonically decreasing function relative to attention. With lower quality content in cooler or lower interest regions of the heat map, abandonment of the content is higher since there is no interesting content coming up. In these instances, user abandonment may only represent fast forwarding of the content to the higher interest points, As such, user abandonment at these portions of the content may be so high that there may be no, or minimal, ad insertion occurrences at these portions.

As described above, a rendering device (or client) for use with the systems and methods described above need not be a personal computer. In an embodiment, the user may be viewing or listening to the song on a portable device, such as an mp3 player, media player, a tablet computing device or a mobile phone. The rendering device may be a purpose built device for interfacing only with the media server or may be a computing device that is provided with the appropriate software.

By way of a non-limiting, in accordance with some exemplary embodiments, of the disclosure, an heat map for a video can be shown under the video status indicator, as known in the art. In this example, the video is that of an octopus that predicts the outcome of World Cup matches by opening one of two boxes containing the opposing team's flags. The heat map illustratively provides the determination that the octopus swims around and does nothing really interesting for most of the video before finally opening one of the boxes near the end. The heat map shows that the end of the video was watched more often than the rest of the video. As such, according to embodiments of the present disclosure, an advertisement would be placed immediately prior to the octopus opening one of the boxes. There would be no benefit for placing additional ads prior to the this portion, or after, as the historical data presented by the heat map illustrates that the majority of viewers fast-forward, or skip to the opening of the box. Additionally, ad insertion prior to the octopus opening the box will maximize the ROI for the advertisers and reduce advertisement fatigue, as users will be less likely to abandon the content because the interesting segment is immediately pending.

FIG. 5 is a block diagram illustrating an internal architecture of an example of a computing device, such as server computer 104 and/or user computing device 102, in accordance with one or more embodiments of the present disclosure. A computing device as referred to herein refers to any device with a processor capable of executing logic or coded instructions, and could be, as understood in context, a server, personal computer, set top box, smart phone, pad computer or media device, to name a few such devices.

As shown in the example of FIG. 5, internal architecture 500 includes one or more processing units (also referred to herein as CPUs) 512, which interface with at least one computer bus 502. Also interfacing with computer bus 502 are persistent storage medium/media 506, network interface 514, memory 504, e.g., random access memory (RAM), run-time transient memory, read only memory (ROM), etc., media disk drive interface 508 as an interface for a drive that can read and/or write to media including removable media such as floppy, CD-ROM, DVD, etc. media, display interface 510 as interface for a monitor or other display device, keyboard interface 516 as interface for a keyboard, pointing device interface 518 as an interface for a mouse or other pointing device, and miscellaneous other interfaces not shown individually, such as parallel and serial port interfaces, a universal serial bus (USB) interface, and the like.

Memory 504 interfaces with computer bus 502 so as to provide information stored in memory 504 to CPU 512 during execution of software programs such as an operating system, application programs, device drivers, and software modules that comprise program code, and/or computer-executable process steps, incorporating functionality described herein, e.g., one or more of process flows described herein. CPU 512 first loads computer-executable process steps from storage, e.g., memory 504, storage medium/media 506, removable media drive, and/or other storage device. CPU 512 can then execute the stored process steps in order to execute the loaded computer-executable process steps. Stored data, e.g., data stored by a storage device, can be accessed by CPU 512 during the execution of computer-executable process steps.

Persistent storage medium/media 506 is a computer readable storage medium(s) that can be used to store software and data, e.g., an operating system and one or more application programs. Persistent storage medium/media 506 can also be used to store device drivers, such as one or more of a digital camera driver, monitor driver, printer driver, scanner driver, or other device drivers, web pages, content files, playlists and other files. Persistent storage medium/media 506 can further include program modules and data files used to implement one or more embodiments of the present disclosure.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “end user” or “user” should be understood to refer to a consumer of data supplied by a data provider. By way of example, and not limitation, the term “user” can refer to a person who receives data provided by the data provider over the Internet in a browser session, or can refer to an automated software application which receives the data and stores or processes the data.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A method comprising:
receiving, at a computing device, a request from a user identifying a media file;
retrieving, via the computing device, the media file from a media file database;
identifying, via the computing device, a log file from a log database corresponding to the media file, the log file comprising quantitative measurements that indicate a popularity of each segment of the media file, the popularity being based on data representing registered attention for each media file segment;
selecting, via the computing device, an advertisement from an advertisement database;
appending, via the computing device, the advertisement to the media file at or around a media file segment having a highest popularity; and
transmitting, from the computing device, the media file and the advertisement to the user over a network.

2. The method of claim 1, wherein said appending further comprises:
inserting the advertisement immediately prior to the segment of the media file having the highest popularity, wherein upon the user rendering the media file and the advertisement, the advertisement will be played immediately prior to the segment with the highest popularity.

3. The method of claim 1, wherein the quantitative measurements for each segment of the media file are based upon a rendering history of the media file.

4. The method of claim 1, wherein the log file further comprises demographic data of the media file.

5. The method of claim 1, wherein said transmitting comprises streaming the media file to the user device associated with the user.

6. The method of claim 1, further comprising:
parsing the retrieved media file to identify associated metadata of the media file, said metadata comprises identifying information of the media file.

7. The method of claim 6, wherein said identifying the log file is based upon the associated metadata of the media file.

8. The method of claim 1, wherein the rendering history of the media file is based upon activity with the media file by a universe of users.

9. The method of claim 1, wherein said advertisement is appended based upon a tiered pricing structure that corresponds to the quantitative measurements of the media file.

10. The method of claim 2, wherein said selecting the advertisement comprises selecting a plurality of advertisements corresponding to a number of popular segments within the media file, wherein the number of popular segments is based upon a threshold to avoid advertisement fatigue.

11. A computer-readable storage medium tangibly comprising computer executable instructions, that when executed by a computing device, perform a method comprising:
receiving a request from a user identifying a media file;
retrieving the media file from a media file database;
identifying a log file from a log database corresponding to the media file, the log file comprising quantitative measurements that indicate a popularity of each segment of the media file, the popularity being based on data representing registered attention for each media file segment;
selecting an advertisement from an advertisement database;
appending the advertisement to the media file at or around a media file segment having a highest popularity; and
transmitting the media file and the advertisement to the user over a network.

12. The computer-readable storage medium of claim 11, wherein said appending further comprises:
inserting the advertisement immediately prior to the segment of the media file having the highest popularity, wherein upon the user rendering the media file and the advertisement, the advertisement will be played immediately prior to the segment with the highest popularity.

13. The computer-readable storage medium of claim 11, wherein the quantitative measurements for each segment of the media file are based upon a rendering history of the media file.

14. The computer-readable storage medium of claim 11, wherein said advertisement is appended based upon a tiered pricing structure that corresponds to the quantitative measurements of the media file.

15. The computer-readable storage medium of claim 11, wherein said transmitting comprises streaming the media file to the user device associated with the user.

16. The computer-readable storage medium of claim 11, further comprising:
parsing the retrieved media file to identify associated metadata of the media file, said metadata comprises identifying information of the media file, wherein said identifying the log file is based upon the associated metadata of the media file.

17. A system comprising:
a plurality of processors:
a media module implemented by at least one of said plurality of processors that retrieves a requested media file from a media file database and streams the requested media file to a rendering device, the requested media file requested by the rendering device;
the media module accesses a log file stored in a log database for the media file, the log file comprising quantitative measurements for segments of the media file, the media module identifies the media file segment having the highest quantitative measurements; and
an advertisement selection module implemented by at least one of said plurality of processors that accesses an advertisement database, selects an advertisement in accordance with the media file segment having the highest quantitative measurements, and transmits the advertisement to the requesting device with the media file segment.

18. The system of claim 17, wherein the quantitative measurements for each media file are calculated by a backend server, the backend server monitors user interaction and behavior when the media files stored in the media file database are being rendered, and stores the interactions and behavior in the log database as log files.

19. The system of claim 18, wherein the backend server calculates the quantitative measurements that identify popularity of each segment of the media file, wherein the identified media file segment having the highest quantitative measurements has a highest popularity among the segments of the media file.

20. The method of claim 17, further comprising:
the media module parses the requested media file to identify associated metadata of the media file, wherein the log file for the media file is identified based upon the metadata of the media file.
